(19) United States
(12) Patent Application Publication
(10) Pub. No.: US 2005/0077068 A1
(43) Pub. Date: Apr. 14, 2005

(54) Structural unit for bipolar electrolysers

(75) Inventors: Fritz Gestermann, Leverkusen (DE); Andreas Bulan, Langenfeld (DE)

Correspondence Address: CONNOLLY BOVE LODGE & HUTZ LLP, SUITE 800, 1990 M STREET NW, WASHINGTON, DC, 20036-3425, US

(73) Assignee: Bayer MaterialScience AG, Leverkusen (DE)

(21) Appl. No.: 10/963,511

(22) Filed: Oct. 14, 2004

(30) Foreign Application Priority Data
Oct. 14, 2003 (DE) 10347703.9

(51) Int. Cl. H02G 3/08; H01J 5/00

(52) U.S. Cl. 174/50

(57) ABSTRACT

The invention describes a structural unit for bipolar electrolysers according to the filter press technique, at least comprising a first half-shell, a second half-shell and a frame-shaped carrier element, in which at least one of the half-shells contains plastics material, the two half-shells are arranged within the carrier element so that the rear wall of the first half-shell and the rear wall of the second half-shell abut one another, the carrier element as well as the two half-shells have at least two openings for the inflow and outflow of electrolyte and/or gas, and the two half-shells have passages lying above one another in the floor for accommodating at least one electrically conducting connecting element, to which is secured in the first half-shell a first electrode and in the second half-shell a second electrode.

### CROSS REFERENCE TO RELATED APPLICATIONS

The present application claims priority under 35 U.S.C. §119 to German Application No. 10347703.9 filed Oct. 14, 2003, the content of which is incorporated herein by reference in its entirety.

### BACKGROUND OF THE INVENTION

1. Field of the Invention

The present invention relates generally to a structural unit for bipolar electrolyzers according to a filter press technique, in particular for the electrolysis of an aqueous solution of hydrogen chloride according to a membrane process.

2. Description of Related Art

As described for example in EP-A 0 785 294, electrochemical cells for the electrolysis of aqueous solutions of hydrogen chloride (hydrochloric acid) normally includes a titanium or a titanium alloy, for example, a titanium-palladium alloy. In EP-A 0 785 294, an oxidizing agent with a redox potential of preferably 0.3-0.6 V compared to a normal hydrogen electrode is added as corrosion protection to the hydrochloric acid. Trivalent iron is chosen as a preferred oxidizing agent. The corrosiveness in the presence of hydrochloric acid however is only one disadvantage of titanium as a material for electrochemical cells. A further disadvantage is the poor conductivity, in which causes voltage losses in the current to the electrodes as well as in the current distribution within the cell. Finally, there is the fact that titanium is a very expensive material.

### SUMMARY OF THE INVENTION

An object of the present invention was accordingly to provide a structural unit for bipolar electrolysers for the electrolysis of aqueous solutions of hydrogen chloride that are less susceptible to corrosion, lead to fewer voltage losses, and at the same time include less expensive materials. A structural unit of the present invention can be typically incorporated according to the generally known filter press technique in an electrolyzer that is operated with a bipolar circuit arrangement.

In accordance with these and other objects, the present invention provides a structural unit suitable for bipolar electrolyzers according to the filter press technique, comprising a first half-shell, a second half-shell and a frame-shaped carrier element. At least one of the half-shells includes a plastics material, and the two half-shells are arranged within the carrier element so that a rear wall of the first half-shell and a rear wall of the second half-shell abut one another. The carrier element as well as the two half-shells comprise at least two openings for the inflow and outflow of electrolyte and/or gas and the two half-shells comprise, in a floor region thereof passages lying above one another for accommodating at least one electrically conducting connecting element. The connecting element is secured in the first half-shell and to a second electrode in the second half-shell.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

The invention is described in more detail hereinafter with reference to the accompanying drawings, in which:

FIG. 1 is a diagrammatic cross-section through the structural element according to the invention,

FIG. 1a is an enlarged section of FIG. 1

FIG. 2 is a diagrammatic section from the structural element according to FIG. 1, which shows in cross-section the half-shells, a first preferred embodiment of a connecting element, and the electrodes.

These figures are illustrated of one embodiment and are not limiting in anyway.

### DETAILED DESCRIPTION OF A PREFERRED EMBODIMENT

In the individual element technique, an electrochemical cell including an anode half-element, a cathode half-element and an ion exchange membrane separating the two half-elements from one another forms a structural unit for an electrolyzer. Contrary to the individual element technique, in the filter press technique, the structural unit is formed from an anode half-element of an electrochemical cell and a cathode half-element of an adjacent electrochemical cell, the two half-elements being arranged back-to-back. In the filter press technique, an electrochemical cell is accordingly formed from a half-element of one structural unit and a half-element of the adjacent structural unit, The two half-elements that form an electrochemical cell are then typically separated from one another by an ion exchange membrane.

The two half-shells of the two adjacent electrochemical cells are inserted into a frame shaped carrier element. The frame shaped carrier together with the two half-shells as well as the connecting elements and the two electrodes serving as cathode and anode form the structural unit according to the invention, preferably are formed of metal, in particular steel or steel coated with plastics material, for example, polyvinylidene fluoride (“PVDF”) or polyvinyl chloride (“PVC”).

In each case the half-shells generally include a floor and a surrounding edge that is, preferably curved, the half shells are inserted into the carrier element via the surrounding edge that lies on the carrier element. The two half-shells, i.e. the anode half-shell and cathode half-shell, are preferably and advantageously inserted into the carrier element so that the half-shells lie back-to-back. That is, the floors of the half-shells preferably lie with their outside surfaces (rear walls) abutting one another. The half-shells may be fabricated in any desired way, e.g., as two separate structural parts, which are joined to one another either detachably or non-detachably. Alternatively the half-shells may also be designed as one piece. Preferably the half-shells are detachably joined to one another.

The floors of the half-shells generally have passages for accommodating connecting elements. If the half-shells are arranged with their rear walls resting against one another, the passages in the half-shells then lie above one another. This enables the connecting elements to be guided through the half-shells. The passages may be of any shape desired including any arbitrary shape, for example, round or angular.

According to a preferred embodiment, the two half-elements of a structural unit are formed by two half-shells and these are joined to one another by a detachable connection. Such an arrangement has an advantage over a simple partition between the two half-elements as known, for example, in EP-A 0 999 294, in that an individual half-shell may be removed from the structural unit and replaced with another half-shell. This facilitates replacement and/or repair if an electrolyzer is damaged or reads to be serviced or otherwise.

The two half-shells of the half-elements may be structurally identical, if desired, though they may have different depths. They may also differ in other respects. A gas diffusion electrode preferably comprises the cathode in the structural unit. In this case, the cathode half-shell is preferably less deep than the anode half-shell, which on the one hand saves material, and on the other hand, saves space for the electrolyzer.

If different materials are used for the half-shells and the carrier element, the different thermal expansions of the materials should be taken into account if necessary. In particular, this applies to the selection of the dimensions of the two half-shells of plastic in relation to the dimensions of the frame-shaped carrier element of metal, as well as to the size of openings for accommodating the connecting element(s) based on the diameter of the connecting element(s). The electrolysis of an aqueous solution of hydrogen chloride is preferably carried out at temperatures ranging from 30° C. to 70° C.

According to the present invention, preferably at least one of the half-shells comprises plastic. Preferably both half-shells are fabricated from plastic. Any plastic can be employed, in particular polyvinyl fluoride (PVDF), polytetrafluoroethylene (PDFE) or chlorinated polyvinyl chloride (CPVC) may be advantageous. An advantage of the present invention thus lies in the fact that structure-imparting structural elements of the electrolyzer are formed of corrosion-resistant, (in particular hydrochloric acid-resistant), and inexpensive materials.

The connecting element(s) may be any desired material, e.g. bolts, pins, screws or the like. One or more connecting element may be employed. Preferably the two half-shells are detachably joined to at least one end of a connecting element, for example a screw/washer connection. In cone embodiment the connecting element is preferably a bolt, pin or the like, that has an outer thread, at least at one end connected by a screw/washer to the anode half-shell on one end and to the cathode half-shell on the other.

The connecting element also performs the function of conducting current to the electrodes in the two half-elements. The connecting element is therefore electrically conductive. In particular the connecting elements comprise any electrically conductive material, e.g. titanium, an acid-resistant titanium alloy, and the like. The element can be coated with an acid-resistant conductive material, e.g. titanium alloy. In one preferred embodiment, the connecting element includes a core of a metal of high electrical conductivity, in particular copper, and a sheath of titanium or a titanium alloy, in particular a titanium-palladium alloy or titanium-ruthenium alloy. In such an embodiment the connecting element advantageously utilizes and takes advantage particularly of the high conductivity of copper.

The two electrodes serving as anode and cathode are typically secured in a low-resistance manner to the connecting elements. For example, they can be welded, i.e. connected in a non-detachable manner, to the connecting elements. This may be accomplished, for example, by using a screw-type or bolt-type connecting element in which the screw head projects into one of the half-shells, for example, the anode half-shell, while the other end of the connecting element with a thread plus thread washer projects into the other half-shell, for example, the cathode half-shell. The electrode, for example, the anode, can then be welded to the screw head of the connecting element. In a preferred embodiment, the electrodes are detachably secured, for example by screwing, to on or more connecting elements. For this purpose, the connections generally passes an inner thread at least at one end. A detachable connection of the electrodes to the connecting elements may be advantageous in some instances since the electrodes can be assembled and dismantled with relatively little effort if they have to be replaced due to wear of the electrochemically active coating and/or damage. In a further preferred embodiment, the electrode serving as the anode can be connected in a non-detachable manner, for example, by welding, to a connecting element, while the electrode serving as the cathode, in particular a gas diffusion electrode, is detachably connected, for example, by screws to connecting element.

The number of connecting elements to be employed depends on many factors, e.g. which material they are made of, the thickness thereof, as well as the transverse conductivity of the anode and cathode. The higher the electrical conductivity of the material and the transverse conductivity of the electrodes, the fewer bolts that may be needed. Also, the more connecting elements that are used, the connecting elements should generally be thinner. The distance between two adjacent connecting elements is in the range from about 10 cm to about 20 cm in one embodiment.

The anode comprises, for example, titanium or a titanium alloy, in particular a titanium-palladium alloy. The anode can be coated with an acid-resistant coating, e.g. one based on a ruthenium-titanium mixed oxide or a ruthenium-titanium-iridium oxide. The cathode may be constructed in a similar way to the anode. Depending on its intended use, the cathode may, however, also be provided with other coatings. In the situation where a gas diffusion electrode is employed as the cathode, a material corresponding to the anode may be used as a carrier for the coating containing the catalyst. For example, a gas diffusion electrode may be used that contains a catalyst of the platinum group, preferably platinum or rhodium. Gas diffusion electrodes from the E-TEK Company (USA) may be mentioned by way of example, which generally contain about 30 wt. % of platinum as catalyst on a carbon substrate with a noble metal coating of about 1.2 mg Pt/cm². However, any gas diffusion electrode can be selected as appropriate. In one preferred embodiment the gas diffusion electrode is operated as an oxygen-consuming cathode.

In addition to the connecting elements, pin-shaped spacer elements can preferably be provided between the anode half-shell and the anode and/or between the cathode half-shell and the cathode. These spacer elements can prevent any possible deformation of the electrodes or half-shells, so that the distance between the anode and the cathode remains generally constant. The spacer elements may for example be pin-shaped or designed having a T-profile or Z-profile or any desired shape. They may be formed, for example of plastic and may be fabricated integrally with the half-shells if desired. However, the spacers may also be connected in any other suitable way to the half-shells and to the electrodes. If the spacer element(s) are desired to improve the current distribution, then they can be electrically conducting. The spacer element(s) may be connected to one another by transverse connecting elements or in any manner. The transverse connecting elements may be any desired material, e.g. wires, netting, fabric or the like. The transverse connecting elements may be electrically conductive in order to improve the current distribution.

The frame-shaped carrier element has can posses, for example, channel-shaped passages for the inflow and outflow of electrolyte and/or gas. In the case where conventional electrodes are used as cathodes and anodes, one inlet and one outlet for electrolyte are typically included in each half-shell, as well as an outlet for chlorine in the anode half-element. Chlorine may optionally also be discharged jointly with the electrolyte if desired. If a gas diffusion electrode is used as the cathode, then gas can be added to the cathode half-element and excess gas as well as liquid are removed from the cathode half-element. For example, one or more tubes that are either detachably or non-detachably connected to the respective half-shell, can be introduced into passages in the carrier element. The passages can channel shaped if desired. For example, the tube may be flanged at one end lying in the interior of the half-shell so that it is displaced from the interior of the half-shell and into the passage.

When assembling a plurality of structural units according to the instant invention to form an electrolyzer according to the filter press principle, the frame-shaped carrier elements are pressed together. The structural units can then be sealed with respect to one another using any commercially available media-resistant seals, such as, for example PTFE or PTFE-containing sealing materials.

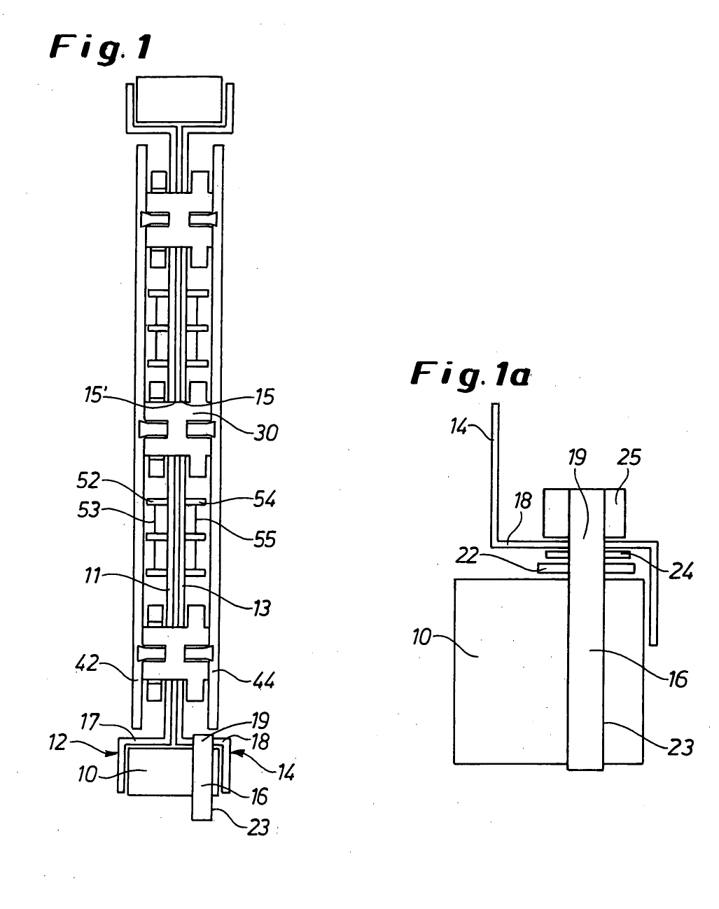

FIG. 1 shows in cross-section a frame-shaped carrier element 10 as well as two half-shells 12, 14, which are inserted back-to-back into the carrier element 10 in the region of the floor 11, 13. The surrounding, curved edge 17, 18 of the half-shells 12, 14 abuts the carrier element 10. For the inflow and/or outflow of electrolyte and/or gas, passages 16, 19 are provided in the carrier element and openings are provided in the half-shells. For example, FIG. 1 shows a channel-shaped passage 16 in the carrier element 10 and an opening 19 in the edge 18 of the half-shell 14. A tube 23 for the inflow or outflow of electrolyte and/or gas is arranged in the passage 16 and the opening 19. In the illustrated embodiment the two half-shells 12, 14 are detachably connected to one another by means of connecting elements 30. The connecting elements 30 pass through superimposed passages 15, 15′ in the floors 11, 13 of the half-shells 12, 14 and project into the half-cells that are formed by the said half-shells 12, 14. Electrodes 42, 44 are secured to the connecting elements.

FIG. 1a shows in an enlargement of a section from FIG. 1 an embodiment of an inflow and an outflow for electrolyte and/or gas. A channel-shaped passage 16 is arranged in the carrier element 10. The half-shell 14 has in its edge 18 an opening 19 that transforms into the passage 16. A tube, in particular metallic tube 23, is inserted into the passage 16 and opening 19. The tube 23 has a flange 25 at the end that faces towards the half-shell. The tube 23 is secured to the edge 18 of the half-shell 14 by means of a screw 22. A seal 24 is provided between the screw 22 and the edge 18 of the half-shell 14.

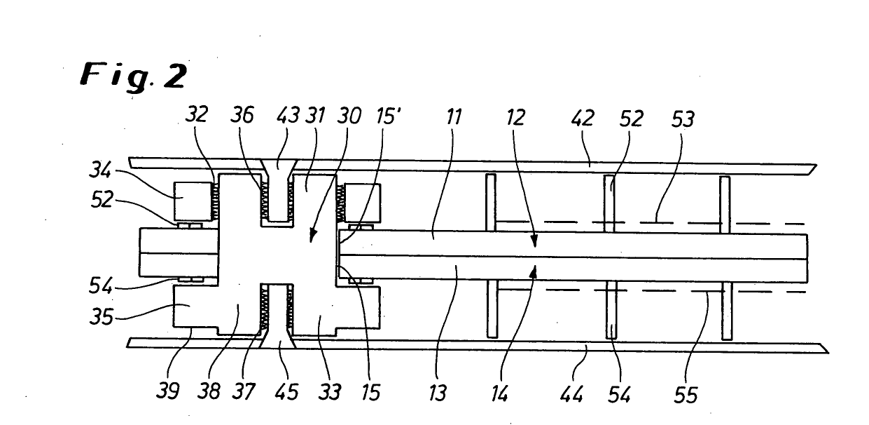

FIG. 2 shows a section of the structural element according to the invention illustrated in FIG. 1. The half-shells 12, 14 lie in the region of the floors 12, 13, with their rear walls abutting and have passages 15, 15′ that merge with one another. The passages 15, 15′ accommodate a connecting element 30. The embodiment of the connecting element 30 illustrated in FIG. 2 resembles a screw. The two ends of the screw-like connecting element 30 project into the space formed by the respective half-shell 12, 14. The two half-shells 12, 14 are detachably connected to one another by means of the connecting elements 30. In the embodiment illustrated in FIG. 2 the connecting element 30 has at one end 31 an outer thread 32 so that the connection can be effected at this end 31 by means of a screw-washer joint 34. The other end 33 of the connecting element 30 has a head 35 whose diameter is larger than the diameter of the passages 15, 15′. This prevents the connecting element 30 slipping through the passages 15, 15′ of the half-shells 12, 14. A seal 52 is provided between the half-shell 12 and the screw washer 34. In a similar way a seal 54 is provided between the half-shell 14 and the head 35 of the connecting element 30. It is also similarly possible to provide both ends 31, 33 of the connecting element 30 with an outer thread 32 and to connect in a similar way the two half-shells 12, 14 by means of a screw-washer joint 34. In the illustrated embodiment the connecting element 30 has a core 38 of copper and a sheath 39 of titanium or a titanium alloy that completely surrounds the core 38.

FIG. 2 also shows an embodiment of a detachable connection of the electrodes 42, 44 to the connecting element 30. The connecting element 30 has at both ends 31, 33, an inner thread 36, 37 so that the electrodes 42, 44 can be connected by means of screws 43, 45 to the said connecting element 30. Alternatively at least one of the electrodes 42, 44 may also be connected by means of welding to the connecting element 30. Preferably the electrode serving as anode is connected by means of welding to the connecting element 30.

Spacer elements 52, 54 as well as transverse connecting elements 53, 55 are furthermore shown in FIG. 2. The for example electrically conducting spacer elements 52, 54 are located in each case between the half-shells 12, 14 and the electrodes 42, 44, and are arranged substantially perpendicular to the said half-shells 12, 14 and electrodes 42, 44. They prevent the electrodes 42, 44 sagging between the connecting elements 30 and thereby ensure a constant spacing between the half-shells 12, 14 and the electrodes 42, 44. The spacer elements 52, 54 are pin-shaped in the illustrated embodiment. The transverse connecting elements 53, 55 may for example likewise be electrically conducting and connect the spacer elements 52, 54 to one another. The current distribution is thereby increased. The transverse connecting elements are wires, netting, fabric or the like.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

All documents referred to herein are specifically incorporated herein by reference in their entireties.

As used herein and in the following claims, articles such as “the”, “a” and “an” can connote the singular or plural.

1. A structural unit suitable for use with a bipolar electrolyzer according to a filter press technique, comprising:
a first half-shell,
a second half-shell and
a frame-shaped carrier element,
wherein at least one of the half-shells comprises a plastic, and further wherein the two half-shells are arranged within the carrier element so that a rear wall of the first half-shell and a rear wall of the second half-shell abut one another, and the carrier element as well as the two half-shells comprise at least two openings for the inflow and outflow of electrolyte and/or gas, and the two half-shells comprise in a floor region thereof, passages lying above one another for accommodating at least one electrically conducting connecting element, to which is secured in the first half-shell, a first electrode and in the second half-shell, a second electrode.

2. A structural unit according to claim 1, wherein the two half-shells are detachably connected to one another.

3. A structural unit according to claim 2, wherein the two half-shells are detachably connected to at least one end of the connecting element by a screw-washer joint.

4. A structural unit according to claim 1, wherein the two half-shells are integrally formed.

5. A structural unit according to claim 1, wherein the first electrode and/or the second electrode is detachably connected to the connecting element.

6. A structural unit according to claim 5, wherein the connecting element has an inner thread on at least one end thereof, and the first electrode and/or second electrode is detachably connected by screws to the connecting elements.

7. A structural unit according to claim 1, further comprising spacer elements provided between the first half-shell and the first electrode and/or between the second half-shell and the second electrode.

8. A structural unit according to claim 7, wherein the spacer elements are electrically conductive and are connected to one another by an electrically conducting transverse connecting element.

9. A structural unit according to claim 1, wherein both half-shells comprise a plastic.

10. A structural unit according to claim 1, wherein the carrier element comprises metal.

11. A structural unit according to claim 1, wherein the connecting element comprises a core of copper and a sheath of titanium or a titanium alloy.

12. A structural unit according to claim 1, wherein one of said electrodes comprises a gas diffusion electrode.

13. A structural unit of claim 9, wherein said plastic comprises polytetrafluoroethylene, PVDF and/or CPVC.

14. A structural unit of claim 10, wherein said metal comprises steel.

15. A structural unit of claim 11, wherein said titanium alloy comprises a titanium-palladium alloy or titanium-ruthenium alloy.

16. A bipolar electrolyzer comprising a structural unit of claim 1.

17. A method for electrolysis of an aqueous solution of HCl comprising:
utilizing a structural unit comprising at least two half shells, at least one of said half shells comprising plastic.

18. A method for servicing an electrolyzer comprising:
removing a half shell from said electrolyzer, and repairing and/or replacing said half shell in said electrolyzer.

19. An electrolyzer adapted for electrolysis of an aqueous solution of HCl comprising:
a structural unit formed of at least two shells, one shell of which comprises plastic and wherein a first electrode is provided in one of said shells and a second electrode is provided in another of said shells.

20. An electrolyzer of claim 19, wherein two half shells are employed, and said two half shells are detachably connected to each other.
